(19) United States
(12) Patent Application Publication
(10) Pub. No.: US 2006/0221644 A1
(43) Pub. Date: Oct. 5, 2006

(54) Backlight assembly and display device having the same

(75) Inventors: Nam-Ok Kwon, Seoul (KR); Min-Gyu Kim, Seoul (KR)

Correspondence Address: David W. Heid;MacPHERSON KWOK CHEN & HEID LLP, Suite 226, 1762 Technology Drive, San Jose, CA, 95110, US

(73) Assignee: Samsung Electronics Co., Ltd., Suwon-si (KR)

(21) Appl. No.: 11/271,027

(22) Filed: Nov. 10, 2005

(30) Foreign Application Priority Data
Mar. 30, 2005 (KR) 2005-26465

(51) Int. Cl. F21V 7/04

(52) U.S. Cl. 362/632

(57) ABSTRACT

A backlight assembly includes a light source, a receiving container, a temperature sensing module and a power source controlling circuit. The light source produces light. The receiving container includes a bottom plate and sidewalls upwardly extending from edge portions of the bottom plate to receive the light source. The bottom plate defines an aperture. The temperature sensing module is disposed at the aperture of the receiving container. The temperature sensing module senses a light source temperature. The power source controlling circuit controls a light source driving voltage according to the temperature of the light source. Therefore, a time for stabilizing the luminance and a power consumption may be reduced.

### CROSS-REFERENCE TO RELATED APPLICATIONS

This application relies for priority upon Korean Patent Application No. 2005-26465 filed on Mar. 30, 2005, the contents of which are herein incorporated by reference in its entirety.

### BACKGROUND

1. Field of the Invention

The present invention relates to a backlight assembly and a display device having the backlight assembly.

2. Description of the Related Art

A liquid crystal display (LCD) device displays an image by using liquid crystal. The LCD device typically comprises two substrates having field-generating electrodes thereon and a liquid crystal (LC) layer interposed between the two substrates. The LCD device has many merits, such as a thin profile, light weight, low driving voltage, low power consumption, etc., so that LCD devices are used in a variety of applications.

The LC layer does itself not emit light, but the LCD device uses light in order to display an image. Therefore, the LCD device utilizes a backlight assembly to produce the light used to display images.

A conventional backlight assembly employs a cold cathode fluorescent lamp (CCFL) having a long cylindrical shape as a light source. As the size of the LCD device increases, the conventional backlight assembly employs more CCFLs, which in turn can increase manufacturing cost. Furthermore, optical characteristics such as luminance uniformity, etc. are deteriorated.

In order to solve the above-mentioned problems, a flat fluorescent lamp has been developed. The flat fluorescent lamp has a plurality of discharge spaces containing discharge gas. When an electric voltage is applied to the discharge gas, an ultraviolet light is generated. The ultraviolet light is converted into visible light by a fluorescent layer formed on an inner face of the flat fluorescent lamp.

The flat fluorescent lamp has high impedance when starting the flat fluorescent lamp, so that starting the flat fluorescent lamp is difficult, and the amount time consumed in order to achieve luminance uniformity is relatively long. In order to solve the above-mentioned problems, a starting voltage that is higher than a driving voltage is applied to the flat fluorescent lamp, so that over-current flows through the flat fluorescent lamp.

However, applying the starting voltage after the flat fluorescent lamp enters a lighting state results in excessive power consumption. Furthermore, a minute hole may be generated at the flat fluorescent lamp body due to the over-current.

### SUMMARY

In accordance with the present invention, a backlight assembly capable of enhancing efficiency by controlling a light source driving voltage that is applied to a flat fluorescent lamp is provided.

In accordance with the present invention, an LCD device having the above backlight assembly is also provided.

In an exemplary backlight assembly according to the present invention, the backlight assembly comprises a light source, a receiving container, a temperature sensing module and a power source controlling circuit. The light source produces light. The receiving container comprises a bottom plate and sidewalls upwardly extending from edge portions of the bottom plate to receive the light source. The bottom plate defines an aperture. The temperature sensing module is disposed at the aperture of the receiving container. The temperature sensing module senses a light source temperature. The power source controlling circuit controls a light source driving voltage according to the temperature of the light source.

In an exemplary liquid crystal display (LCD) device according to an exemplary embodiment of the present invention, the LCD device comprises an LCD panel and a backlight assembly. The LCD panel displays an image by using light. The backlight assembly provides the LCD panel with the light. The backlight assembly comprises a light source, a receiving container, a temperature sensing module and a power source controlling circuit. The light source produces light. The receiving container comprises a bottom plate and sidewalls upwardly extended from edge portions of the bottom plate to receive the light source. The bottom plate defines an aperture. The temperature sensing module is disposed at the aperture of the receiving container. The temperature sensing module senses a light source temperature. The power source controlling circuit controls a light source driving voltage according to the temperature of the light source.

Therefore, a time for achieving uniformity in the luminance and power consumption may be reduced. Furthermore, the light source temperature may be detected accurately by inserting into the aperture formed at the receiving container a thermistor of the temperature sensing module for detecting the temperature of the flat fluorescent lamp.

### BRIEF DESCRIPTION OF THE DRAWINGS

The above and other features and advantages of the present invention will become more apparent by describing in detail exemplary embodiments thereof with reference to the accompanying drawings, in which:

FIG. 1 is an exploded perspective view illustrating a backlight assembly according to an exemplary embodiment of the present invention;

FIG. 2 is a plan view illustrating a backside of the backlight assembly in FIG. 1;

FIG. 3 is a cross-sectional view taken along a line I-I′ in FIG. 2;

FIG. 4 is a perspective view illustrating a temperature sensing module in FIG. 1;

FIG. 5 is a plan view illustrating a backlight assembly according to another exemplary embodiment of the present invention;

FIG. 6 is a perspective view illustrating a temperature sensing module according to another exemplary embodiment of the present invention;

FIG. 7 is a perspective view illustrating a flat fluorescent lamp in FIG. 1;

FIG. 8 is a cross-sectional view taken along a line II-II′ in FIG. 7; and

FIG. 9 is an exploded perspective view illustrating a liquid crystal display device according to an exemplary embodiment of the present invention.

### DETAILED DESCRIPTION

It should be understood that the exemplary embodiments of the present invention described below may be varied and modified in many different ways without departing from the inventive principles disclosed herein, and the scope of the present invention is therefore not limited to these particular embodiments. Rather, these embodiments are provided so that this disclosure will be thorough and complete, and will fully convey the concept of the invention to those skilled in the art by way of example and not of limitation. For example, the embodiment of the present invention will be explained by using a flat fluorescent lamp. However, the present invention may be applied to a backlight assembly employing other types of light sources, such as, e.g., a cold cathode fluorescent lamp (CCFL) or a light emitting diode (LED).

Hereinafter, the embodiments of the present invention will be described in detail with reference to the accompanied drawings.

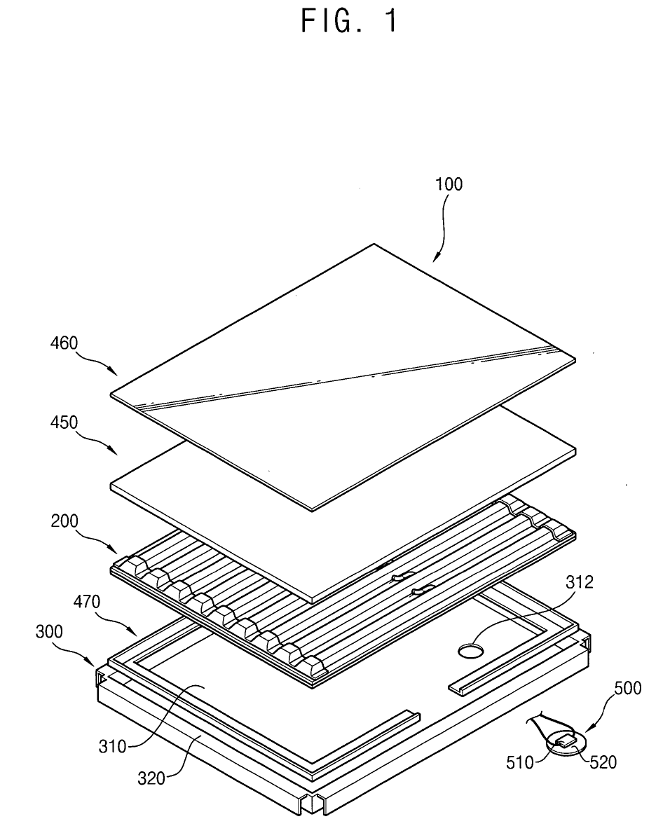

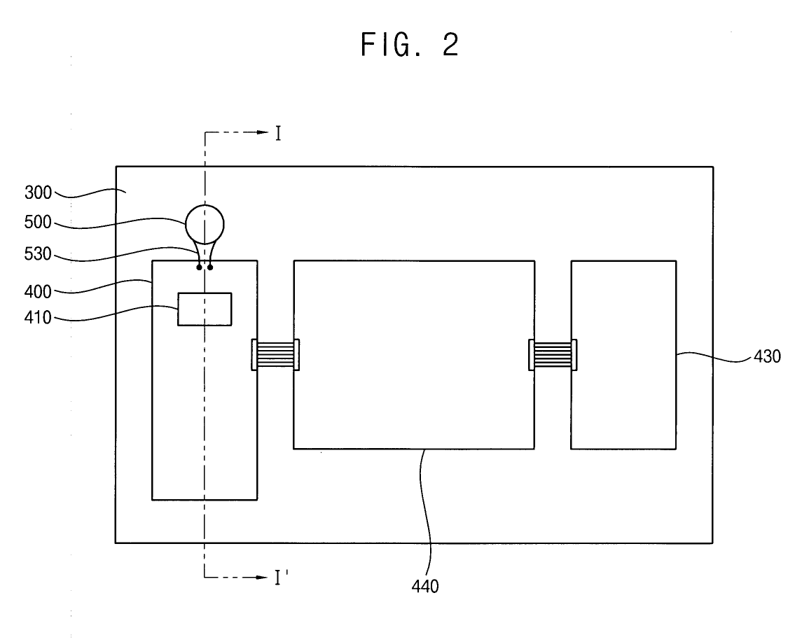

FIG. 1 is an exploded perspective view illustrating a backlight assembly according to an exemplary embodiment of the present invention, and FIG. 2 is a plan view illustrating a backside of the backlight assembly in FIG. 1.

Referring to FIGS. 1 and 2, a backlight assembly 100 according to the present embodiment comprises a flat fluorescent lamp 200, a receiving container 300, an inverter board 400, a temperature sensing module 500 and a power source controlling circuit 410.

The flat fluorescent lamp 200 is disposed in a receiving space of the receiving container 300. The flat fluorescent lamp 200 comprises a plurality of discharge spaces spaced apart from each other. The flat fluorescent lamp 200 has, for example, a rectangular plate shape from a plan view perspective. When a lamp driving voltage is applied to the flat fluorescent lamp 200, a plasma discharge is induced in a plurality of discharge spaces to generate ultraviolet light. The ultraviolet light is converted into visible light by a fluorescent layer formed on an inner face of the flat fluorescent lamp 200. The flat fluorescent lamp 200 has a relatively large area, so that an inner space of the flat fluorescent lamp is divided into the plurality of discharge spaces in order to enhance light-emitting efficiency.

The receiving container 300 comprises a bottom plate 310 and sidewalls 320 upwardly extended from edge portion of the bottom plate 310. The sidewalls 320 have, for example, an inverted U-shape in order to be combined with other parts.

The receiving container 300 comprises, for example, a metal having a relatively high strength. In other embodiments, other materials may also be used.

The receiving container 300 includes a aperture or hole 312 for coupling with the temperature sensing module 500. The hole 312 is formed at the bottom plate 310 of the receiving container 300. A position of the hole 312 may be changed according to a position of the power source controlling circuit 410. For example, the hole 312 may be disposed adjacent to the power source controlling circuit 410.

The inverter board 400 is disposed on a back side of the receiving container 300, opposite the flat fluorescent lamp 200, and adjacent to the hole 312. The inverter board 400 converts an external alternating voltage into a driving voltage having higher absolute value than that of the external alternating voltage. The inverter board 400 applies the driving voltage to the flat fluorescent lamp 200.

The temperature sensing module 500 is also disposed on the back side of the receiving container 300, opposite the flat fluorescent lamp 200. The temperature sensing module 500 is positioned to correspond to the hole 312. The temperature sensing module 500 senses a temperature of the flat fluorescent lamp 200, and applies an electrical signal corresponding to the sensed temperature to the power source controlling circuit 410.

The temperature sensing module 500 comprises a thermistor 510 and a flexible film 520. The thermistor 510 has an electric resistance that varies according to the temperature of the thermistor 510. The thermistor 510 is disposed on the flexible film 520. In detail, the thermistor 510 is fixed at a center portion of the flexible film 520 by, e.g., an adhesive tape, soldering, or other adhesive. The flexible film 520 is disposed on the backside of the receiving container 300 such that the thermistor 510 is inserted into the hole 312. For example, the flexible film 520 is attached at the backside of the receiving container 300 through an adhesive film. In the embodiment shown in FIG. 1, where the hole 312 has a circular shape, the flexible film 520 has a circular shape with a larger diameter, such that the outer regions of the flexible film 520 can be attached to the receiving container 300.

A luminance of the flat fluorescent lamp 200 increases as a temperature of the flat fluorescent lamp 200 increases, so that the luminance of the flat fluorescent lamp 200 may be detected by measuring the temperature of the flat fluorescent lamp 200.

The power source controlling circuit 410 controls the flat fluorescent lamp 200 according to the measured temperature. The power source controlling circuit 410 raises a driving voltage when the measured temperature is lower than a previously-determined reference temperature, and lowers the driving voltage when the measured temperature is higher than a reference temperature. In other words, the power source controlling circuit 410 raises the driving voltage in order to reduce the time consumed for stabilizing the luminance when initially starting the flat fluorescent lamp 200, and lowers the driving voltage in order to reduce power consumption and prevent damage to the flat fluorescent lamp 200 after the luminance is stabilized.

In other embodiments, the power source controlling circuit 410 controls the flat fluorescent lamp 200 according to a reference temperature range. For example, if the measured temperature is within the predetermined reference temperature range, the power source controlling circuit 410 maintains the current driving voltage. If the measure temperature drops below a low end of the reference temperature range, the power source controlling circuit 410 raises the driving voltage. If the measure temperature rises above a high end of the reference temperature range, the power source controlling circuit 410 lowers the driving voltage.

The power source controlling circuit 410 is disposed on the inverter board 400. The temperature sensing module 500 produces an electrical signal corresponding to the measured temperature. The electrical signal produced by the temperature sensing module 500 is applied to the power source controlling circuit 410 formed on the inverter board 400 through the wires 530. In order to reduce power dissipation through the wires 530 and electrical noise, the temperature sensing module 500 is disposed adjacent to the inverter board 400. Therefore, the hole 312 formed at the receiving container 300 is disposed adjacent to the inverter board 400.

The backlight assembly 100 further comprises an A/D converter board 430 and a power supplying module 440. The A/D converter board 430 converts a primitive image signal that corresponds to an analog signal into an image signal corresponding to a digital signal. The A/D converter board 430 and the power supplying module 440 are disposed on the back side of the receiving container 300, opposite the flat fluorescent lamp 200.

The backlight assembly 100 further comprises a buffering member 470. The buffering member 470 is disposed between the flat fluorescent lamp 200 and the receiving container 300 to support the flat fluorescent lamp 200. The buffering member 470 is disposed along edge portions of the receiving container 300. The buffering member 470 comprises a dielectric material to electrically isolate the flat fluorescent lamp 200 from the metal receiving container 300. The buffering member 470 may comprise a flexible material in order to absorb external impact and reduce vibration. According to the present embodiment, the buffering member 470 comprises, for example, silicone. The buffering member 470 may comprise two buffering members 470, each buffering member 470 having, for example, a U-shape. The two U-shaped buffering members 470 may be arranged to form a rectangular shape corresponding to the shape of the flat fluorescent lamp 200. Alternatively, the buffering member 470 may have a rectangular frame shape. Alternatively, the buffering member 470 may have an L-shape, and four buffering members having the L-shape may be disposed at four corners of the receiving container 300, respectively.

The backlight assembly 100 further comprises a light diffusing plate 450, and at least one optical member 460.

The light diffusing plate 450 diffuses light generated by the flat fluorescent lamp 200 to enhance luminance uniformity. The light diffusing plate 450 may have a rectangular plate shape corresponding to the shape of the flat fluorescent lamp 200. The light diffusing plate 450 is spaced apart from the flat fluorescent lamp 200. The light diffusing plate 450 comprises an optically transparent material such as, e.g., polymethylmethacrylate (PMMA), and comprises a light diffusing agent.

The optical member 460 is disposed on the light diffusing plate 450. The optical member 460 further enhances the luminance uniformity. The optical member 460 may comprise a light condensing sheet for enhancing front view luminance. The optical member 460 may also comprise various optical sheets having various functions.

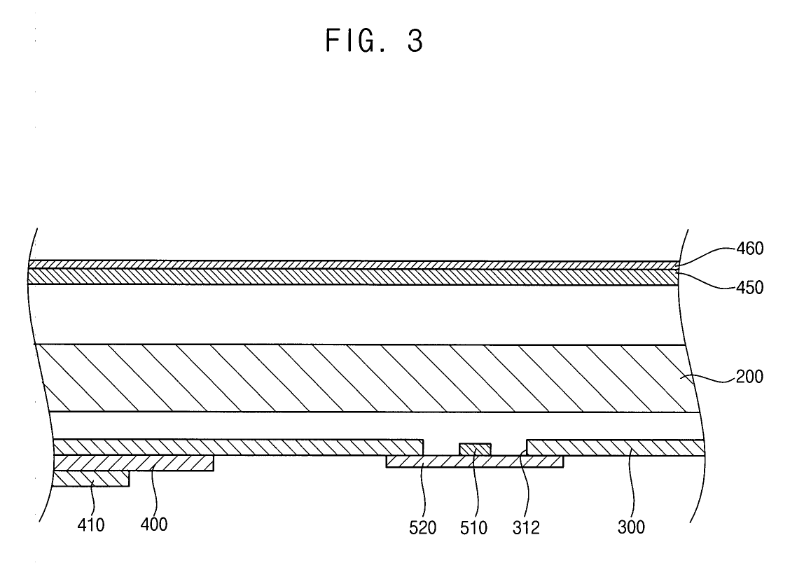

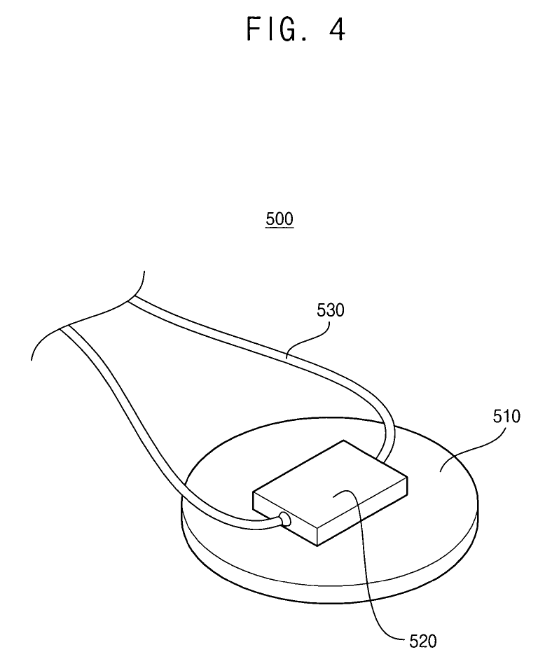

FIG. 3 is a cross-sectional view taken along a line I-I′ in FIG. 2, and FIG. 4 is a perspective view illustrating a temperature sensing module in FIG. 1.

Referring to FIGS. 3 and 4, the temperature sensing module 500 comprises the thermistor 510 for sensing a temperature of the flat fluorescent lamp 200, and the flexible film 520 for supporting the thermistor 510.

The thermistor 510 is attached to the flexible film 520, using, e.g., adhesive tape, soldering, or other adhesive. The thermistor 510 has an electrical resistance that varies according to the temperature of the thermistor 510. The thermistor 510 applies a variable resistance corresponding to the temperature measured from the flat fluorescent lamp 200 to a n electrical signal from the power source controlling circuit 410.

The thermistor 510 is inserted into the hole 312 for accurate detection of the temperature of the flat fluorescent lamp 200. In detail, when the thermistor 510 is inserted into the hole 312, the thermistor 510 faces directly the flat fluorescent lamp 200, so that the thermistor 510 may detect the temperature of the flat fluorescent lamp 200 more accurately.

The flexible film 520 is attached to the backside of the receiving container 300 such that the thermistor 510 is inserted into the hole 312. The flexible film 520 is attached to the backside of the receiving container 300, for example, using an adhesive tape. The flexible film 520 may comprise a thin and flexible material, so that the flexible film 520 may be easily attached to the backside of the receiving container 300 without increasing volume.

The temperature sensing module 500 further comprises the wires 530. An amount of current that flows through the wires 530 is changed by the thermistor 510 that has a variable electrical resistance in accordance with temperature.

A first end of the wires 530 is electrically connected to the thermistor 510, and a second end of the wires 530 is electrically connected to inverter board 400 having the power source controlling circuit 410 formed thereon.

When the wires 530 become longer, power consumption and electric noise increase. Therefore, in order to reduce a length of the wires 530, the hole 312 is positioned adjacent to the location of the inverter board 400 having the power source controlling circuit 410 formed thereon.

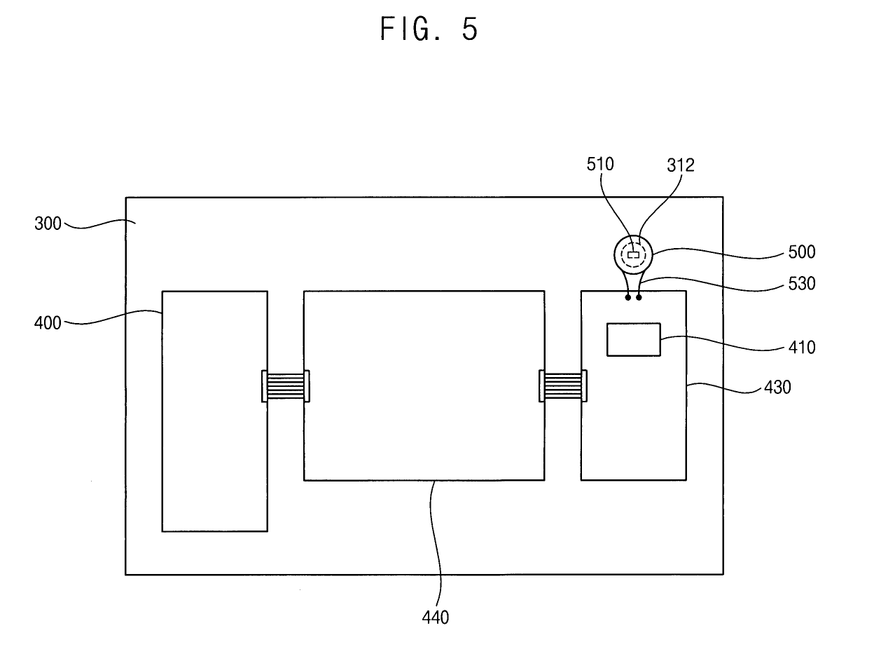

FIG. 5 is a plan view illustrating a backlight assembly according to another exemplary embodiment of the present invention. The backlight assembly of the present embodiment is substantially the same as in the above-explained embodiment in FIGS. 1 through 4 except with respect to the position of the temperature sensing module and power source controlling circuit. Thus, the same reference numerals will be used to refer to the same or similar parts as those described in the above-explained embodiment and any further explanation concerning the above elements will be omitted.

Referring to FIG. 5, a temperature sensing module 500 is disposed such that the temperature sensing module 500 is adjacent to an A/D converter board 430. The power source controlling circuit 410 is disposed on the A/D converter board 430. Therefore, the hole 312 of the receiving container 300, which receives the thermistor 510, is positioned such that the hole 312 is adjacent to the A/D converter board 430.

The thermistor 510 modulates an amount of current that flows through the wires 530 in accordance with the temperature measured from the flat fluorescent lamp.

The electric signal from the thermistor 510 is applied to the power source controlling circuit 410 through the wires 530. The power source controlling circuit 410 compares the electric signal containing information regarding the measured temperature with a reference that is previously set, and generates a control signal for controlling the driving voltage of the flat fluorescent lamp. The control signal is applied to the inverter board 400 through the power supplying module 440. Alternatively, the control signal may be applied directly to the inverter board 400.

The power source controlling circuit 410 may be disposed on the inverter board 400. When the power source control circuit 410 is formed on the inverter board 400, information of regarding the temperature detected by the thermistor 510 is applied to the A/D converter board 430 through the wires 530, and transferred to the power source controlling circuit 410 formed at the inverter board 400 through the power supplying module 440.

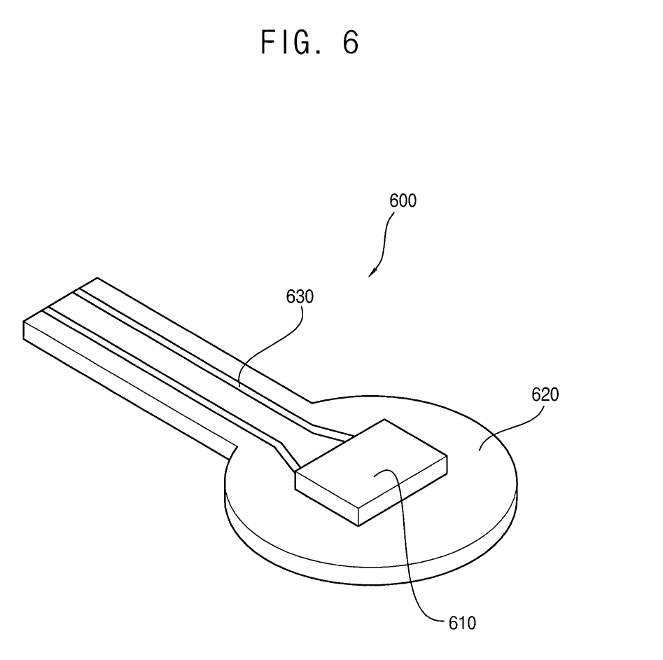

FIG. 6 is a perspective view illustrating a temperature sensing module according to another exemplary embodiment of the present invention.

Referring to FIG. 6, a temperature sensing module 600 according to the present embodiment comprises a thermistor 610 for measuring a temperature, and a flexible film 620 supporting the thermistor 610.

The thermistor 610 has an electrical resistance that changes according to the temperature of the thermistor 610. The thermistor 610 is fixed to the flexible film 620, for example, using an adhesive tape, soldering, or other adhesive.

The flexible film 620 may comprise a thin and flexible material. The flexible film 620 has a wiring pattern 630 formed thereon. The wiring pattern 630 electrically connects the thermistor 610 to the power source controlling circuit 410 in FIG. 2. The wiring pattern 630 may electrically connect the thermistor 610 to the power source controlling circuit 410 in a more stable and reliable fashion than the wires 530 in FIG. 4.

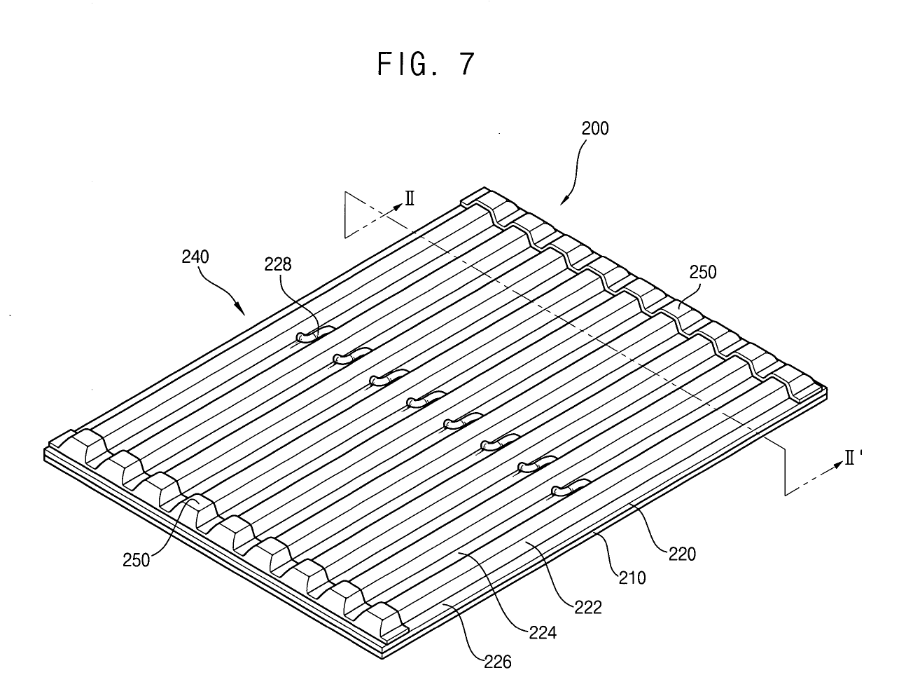

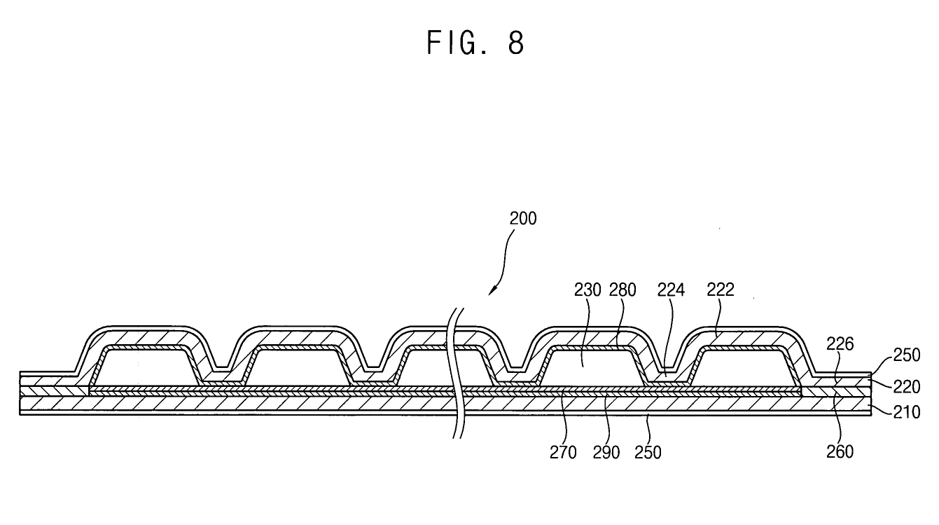

FIG. 7 is a perspective view illustrating a flat fluorescent lamp in FIG. 1, and FIG. 8 is a cross-sectional view taken along a line II-II′ in FIG. 7.

Referring to FIGS. 7 and 8, a flat fluorescent lamp 200 comprises a lamp body 240 and a pair of electrodes 250. The lamp body 240 comprises a plurality of discharge spaces 230 spaced apart from each other. The electrodes 250 are disposed at first and second ends of the lamp body 240, respectively. The electrodes 250 extend in a first direction and the discharge spaces 230 extend in a second direction that is substantially perpendicular to the first direction.

The lamp body 240 comprises a first substrate 210 and a second substrate 220 combined with the first substrate 210 to form the discharge spaces 230.

The first substrate 210 may have, e.g., a rectangular plate shape. The first substrate 210 comprises, for example, glass. The first substrate 210 optionally comprises an ultraviolet light blocking material in order to prevent leakage of ultraviolet light.

The second substrate 220 defines a plurality of furrows for forming the discharge spaces 230 when the second substrate 220 is mated with the first substrate 210. The second substrate 220 is optically transparent, so that visible light may pass through the second substrate 220. The second substrate 220 optionally comprises an ultraviolet light blocking material in order to prevent leakage of ultraviolet light.

The furrows of the second substrate 220 may be formed through various methods. For example, a flat plate may be heated and compressed using molding patterns. Alternatively, air may be blown onto the heated flat plate to form the furrows.

The second substrate 220 comprises a plurality of discharge space portions 222, a plurality of space dividing portions 224, and a sealing portion 226. The discharge space portions 222 are spaced apart from the first substrate 210 to define the discharge spaces 230 when the first and second substrates 210 and 220 are combined with each other. Each of the space dividing portions 224 is disposed between two discharge space portions 222 adjacent to each other, and the space dividing portions 224 make contact with the first substrate 210 when the first and second substrates 210 and 220 are combined with each other. The sealing portion 226 is disposed at edge portions of the second substrate 220. The first and second substrates 210 and 220 are combined with each other through the sealing portion 226.

Each of the discharge portions 222 has an arch-shape. Alternatively, each of the discharge portions 222 may have various cross-sectional shapes such as, e.g., a semi-circular shape, a rectangular shape, a trapezoidal shape, etc.

The second substrate 220 comprises connection paths 228. The connection paths 228 connect two discharge spaces 230 adjacent to each other. At least one connection path 228 is disposed at each of the space diving portion 224. Gas may move through the connection path 228 when air in the discharge spaces 230 is exhausted or discharge gas is injected into the discharge spaces 230. The connection path 228 may be formed through a process of forming the second substrate 220. The connection path 228 may have various shapes. The connection path 228 has, for example, an S-shape. When a length of the connection path 228 increases, an interference between the discharge spaces 230 is reduced to prevent a channeling effect, which would induce deterioration.

The first and second substrates 210 and 220 are combined with a sealing member 260 such as frit. The frit comprises glass and metal. The frit has a lower melting point than the glass. The frit 260 is disposed between the first and second substrates 210 and 220 at the sealing portion 226. The frit is heated to be melted in order to combine the first and second substrates 210 and 220. The combining process may be performed at a temperature of about 400° C. to about 600° C.

The space diving portions 224 of the second substrate 220 make contact with the first substrate 210 as a result of a pressure difference between atmosphere and discharge spaces 230. When the first and second substrates 210 and 220 are combined with each other, air in the discharge spaces 230 is exhausted, and then discharge gas including mercury (Hg), neon (Ne), argon (Ar), etc. is injected into the discharge spaces 230 until a pressure of the discharge spaces 230 is to be in a range of about 50 torr to about 70 torr. The atmospheric pressure is about 760 torr. Therefore, the space dividing portions 224 make contact with the first substrate 210 by the pressure difference between the discharge spaces 230 and atmosphere.

The lamp body 200 further comprises a first fluorescent layer 270 and a second fluorescent layer 280. The first fluorescent layer 270 is formed on an inner face of the first substrate 210, and the second fluorescent layer 280 is formed on an inner face of the second substrate 220. The first and second fluorescent layers 270 and 280 convert ultraviolet light generated by the discharge gas into visible light.

The lamp body 200 further comprises a light reflecting layer 290. The light reflecting layer 290 is disposed between the first substrate 210 and the first fluorescent layer 270. The light reflecting layer 290 reflects visible light toward the second substrate 220 to prevent leakage of the visible light. The light reflecting layer 290 enhances reflectivity and reduces a change of color coordinate. The light reflecting layer 290 may comprise a metal oxide such as, e.g., aluminum oxide (Al₂O₃) or barium sulfate (BaSO₄).

The first fluorescent layer 270, the second fluorescent layer 280, and the light reflecting layer 290 are formed, for example, using a spraying method before the first and second substrates 210 and 220 are combined with each other. The first fluorescent layer 270, the second fluorescent layer 280, and the light reflecting layer 290 are formed on all portions of the inner faces except for the sealing portion 226. Alternatively, the first fluorescent layer 270, the second fluorescent layer 280, and the light reflecting layer 290 may not be formed in the space dividing portions 224.

The lamp body 200 optionally comprises a protection layer (not shown) interposed between the first substrate 210 and the light reflecting layer 290. The protection layer may also be interposed between the second substrate 220 and second fluorescent layer 280. The protection layer prevents chemical reaction between mercury in the discharge gas and glass of the first and second substrates 210 and 220, so that mercury loss and blackening of the first and second substrates 210 and 220 are prevented.

The pair of electrodes 250 are disposed at first and second ends of the lamp body 240, respectively. The electrodes 250 overlap all discharge spaces 230. The electrodes 250 are disposed on an outer face of the second substrate 220. The flat fluorescent lamp 200 optionally comprises another pair of electrodes formed on an outer face of the first substrate 210. The flat fluorescent lamp 200 may further comprise a conducting clip (not shown) that electrically connects one of the electrodes 250 disposed on the outer face of the second substrate 220 with an electrode disposed on the outer face of the first substrate 210. The pair of electrodes 250 may be disposed inside of the lamp body 250.

The electrode 250 comprises an electrically conducting material. The electrodes 250 apply electrical power provided by the inverter board 400 in FIG. 2 to the lamp body 240. Silver paste including silver (Ag) and silicon oxide (SiO₂) may be coated on the outer face of the lamp body 240 to form the electrode 250. Alternatively, metal powder may be coated through a spray coating method to form the electrode 250. An insulating layer (not shown) may be formed on the electrode 250 in order to protect the electrode 250.

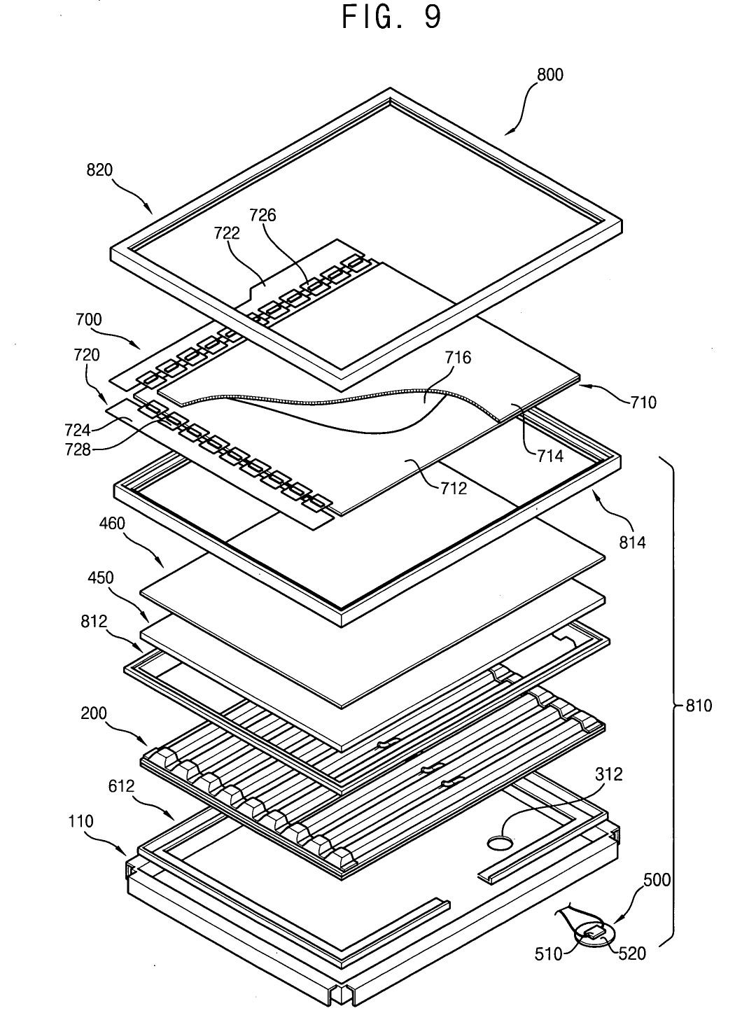

FIG. 9 is an exploded perspective view illustrating a liquid crystal display device according to an exemplary embodiment of the present invention.

Referring to FIG. 9, a liquid crystal display (LCD) device 800 according to the present embodiment comprises a backlight assembly 810 and a display unit 700. The backlight assembly 810 provides the display unit 700 with light. The display unit 700 displays an image by using the light provided by the backlight assembly 810.

The backlight assembly 810 of the present embodiment is substantially the same as the above-described backlight assembly in FIG. 1, except for the addition of a first mold 812 and a second mold 814. Thus, the same reference numerals will be used to refer to the same or similar parts as those described in FIG. 1 and any further explanation concerning the above elements will be omitted.

The backlight assembly 810 optionally comprises a first mold 812. The first mold 812 is disposed between the flat fluorescent lamp 200 and the light diffusing plate 450. The first mold 812 fixes edge portions of the flat fluorescent lamp 200 and supports edge portions of the light diffusing plate 450 and the optical member 460. The first mold 812 may have a rectangular frame shape. Alternatively, the first mold 812 may comprise two U-shaped pieces or four L-shaped pieces.

The backlight assembly 810 may further comprise a second mold 814. The second mold 814 is disposed between the optical member 460 and the display unit 700. The second mold 814 fixes edge portions of the light diffusing plate 450 and the optical member 460. The second mold 814 further supports edge portions of an LCD panel 710. The second mold 814 may have a rectangular frame shape. Alternatively, the second mold 814 may comprise two U-shaped pieces or four L-shaped pieces.

The display unit 710 comprises an array substrate 712, a color filter substrate 714 that is combined with the array substrate 712, and a liquid crystal layer 716 disposed between the array substrate 712 and the color filter substrate 714.

The array substrate 712 comprises a plurality of thin film transistors (TFTs) arranged in a matrix shape. Each of the TFTs comprises a gate electrode that is electrically connected to one of gate lines, a source electrode that is electrically connected to one of data lines, or a drain electrode that is electrically connected to a pixel electrode including an optically transparent and electrically conductive material.

The color filter substrate 714 comprises red color filters ‘R’, green color filters ‘G’, and blue color filters ‘B’. The color filter substrate 714 further comprises a common electrode including an optically transparent and electrically conductive material.

When a gate voltage is applied to the gate electrode of the TFT, the TFT is turned on, so that the data voltage is applied to the pixel electrode through the TFT. When the data voltage is applied to the pixel electrode, electric fields are generated between the pixel electrode and the common electrode to alter an arrangement of liquid crystal molecules of the liquid crystal layer 716. When the arrangement of liquid crystal molecules of the liquid crystal layer 716 is altered, the optical transmissivity of the liquid crystal layer 716 is changed, so that when light generated from the backlight assembly 810 passes through the liquid crystal layer 716, an image is displayed.

The LCD device 800 further comprises a driver circuit portion 720. The driver circuit portion 720 comprises a data printed circuit board (data PCB) 722, a gate printed circuit board (gate PCB) 724, a data flexible printed circuit (data FPC) 726, and a gate flexible printed circuit (gate FPC) 728. The data PCB 722 provides the LCD panel 710 with a data driving signal. The gate PCB 724 provides the LCD panel 710 with a gate driving signal. The data FPC 726 connects the data PCB 722 to the LCD panel 710. The gate FPC 728 connects the gate PCB 724 to the LCD panel 710.

A tape carrier package (TCP) or a chip on film (COF) may be employed as the data and gate FPCs 726 and 728. Alternatively, the LCD panel 710 may comprise a gate driving circuit, in which case the gate PCB 724 and the gate FPC 728 are not required.

The LCD device 800 further comprises a top chassis 820 for enclosing the display unit 700. The top chassis 820 is combined with the receiving container 300 to enclose and retain the LCD panel 710. When enclosed within the top chassis 820 and the receiving container 300, the data FPC 726 is bent, causing the data PCB 722 to be disposed at a side of the receiving container 300 or a bottom of the receiving container 300. The top chassis 820 comprises a metal having relatively high strength.

According to the present invention, the flat fluorescent lamp is driven according to a temperature of the flat fluorescent lamp, so that a time for stabilizing the luminance and a power consumption may be reduced.

Furthermore, the temperature of the flat fluorescent lamp may be detected accurately by inserting the thermistor for detecting the temperature of the flat fluorescent lamp into a hole formed at the receiving container.

Having described the exemplary embodiments of the present invention and its advantages, it is noted that various changes, substitutions, and alterations can be made herein without departing from the spirit and scope of the invention as defined by the appended claims.

What is claimed is:

1. A backlight assembly comprising:
a light source for producing light;
a receiving container to receive the light source, said receiving container comprising a bottom plate defining an aperture;
a temperature sensing module disposed at the aperture of the receiving container, the temperature sensing module sensing a temperature of the light source; and
a power source controlling circuit for controlling a light source driving voltage according to the temperature of the light source.

2. The backlight assembly of claim 1, wherein the temperature sensing module comprises:
a thermistor having an electric resistance that varies according to the light source temperature; and
a flexible film having the thermistor disposed thereon, the flexible film being attached to a back side of the receiving container opposite the light source such that the thermistor is inserted into the hole.

3. The backlight assembly of claim 2, wherein the temperature sensing module further comprises wires that electrically connect the thermistor to the power source controlling circuit.

4. The backlight assembly of claim 2, wherein the flexible film comprises a wiring pattern that electrically connects the thermistor to the power source controlling circuit.

5. The backlight assembly of claim 1, wherein the power source controlling circuit raises the light source driving voltage when the light source temperature sensed by the temperature sensing module is lower than a reference temperature, and lowers the light source driving voltage when the light source temperature sensed by the temperature sensing module is higher than the reference temperature.

6. The backlight assembly of claim 1, further comprising an inverter board disposed at a backside of the receiving container, the inverter board generating the light source driving voltage.

7. The backlight assembly of claim 6, wherein the power source controlling circuit is formed at the inverter board.

8. The backlight assembly of claim 7, wherein the hole is adjacent to the inverter board.

9. The backlight assembly of claim 1, further comprising an A/D converter board disposed at a backside of the receiving container, the A/D converter board converting an external analog signal into a digital signal.

10. The backlight assembly of claim 9, wherein the power source controlling circuit is formed on the A/D converter board.

11. The backlight assembly of claim 10, wherein the hole is adjacent to the A/D converter board.

12. The backlight assembly of claim 1, wherein the light source comprises:
a light source body having a plurality of discharge spaces spaced apart from each other; and
a pair of electrodes disposed at first and second ends of the light source body, respectively.

13. The backlight assembly of claim 12, wherein the light source body comprises:
a first substrate; and
a second substrate comprising a plurality of furrows defining the discharge spaces.

14. The backlight assembly of claim 1, further comprising:
a buffering member disposed between the light source and the receiving container to support the light source.

15. The backlight assembly of claim 14, further comprising:
a light diffusing plate disposed on the light source, the light diffusing plate diffusing light generated by the light source; and
an optical member disposed on the light diffusing plate to enhance optical properties of the light.

16. A liquid crystal display (LCD) device comprising:
an LCD panel; and
a backlight assembly that provides the LCD panel with light, the backlight assembly comprising:
a light source for producing light;
a receiving container to receive the light source, said receiving container comprising a bottom plate defining an aperture;
a temperature sensing module disposed at the aperture of the receiving container, the temperature sensing module sensing a temperature of the light source; and
a power source controlling circuit for controlling a light source driving voltage according to the temperature of the light source.

17. The LCD device of claim 16, wherein the temperature sensing module comprises:
a thermistor having an electric resistance that varies according to the light source temperature; and
a flexible film having the thermistor disposed thereon, the flexible film being attached to a backside of the receiving container opposite the light source such that the thermistor is inserted into the hole.

18. The LCD device of claim 16, wherein the power source controlling circuit raises the light source driving voltage when the light source temperature sensed by the temperature sensing module is lower than a reference temperature, and lowers the light source driving voltage when the light source temperature sensed by the temperature sensing module is higher than the reference temperature.

19. The LCD device of claim 16, further comprising:
an inverter board disposed at a back side of the receiving container, the inverter board generating the light source driving voltage; and
an A/D converter board disposed at a backside of the receiving container, the A/D converter board converting an external analog signal into a digital signal.

20. The LCD device of claim 19, wherein the power source controlling circuit is formed at one of the inverter board and the A/D converter board.

21. The LCD device of claim 20, wherein the hole is adjacent to one of the inverter board and the A/D converter board.
